(19) United States
(12) Patent Application Publication
(10) Pub. No.: US 2016/0129509 A1
(43) Pub. Date: May 12, 2016

(54) Transmission Mechanism for Double-Blade Electric Saw

(71) Applicant: NINGBO GEMAY INDUSTRY CO., LTD., Zhejiang (CN)

(72) Inventors: Xuefeng Xu, Ningbo, Zhejiang (CN); Tao Lu, Ningbo, Zhejiang (CN)

(21) Appl. No.: 14/897,238

(22) PCT Filed: Dec. 19, 2013
(86) PCT No.: PCT/CN2013/001596

§ 371 Date: Dec. 9, 2015

(30) Foreign Application Priority Data
Jun. 26, 2013 (CN) 201310261386.7

(51) Int. Cl. B23D 51/16; B23D 49/16; B23D 49/00

(52) U.S. Cl. CPC B23D 51/16; B23D 49/006; B23D 49/16

(57) ABSTRACT

The present invention relates to a transmission mechanism for an electric two-blade saw, comprising a transmission gear set installed in a housing and driven to rotate by a motor, a first saw blade and a second saw blade; the first and second saw blades are respectively installed on a first base with a first rack and a second base with a second rack; the first and second racks are engaged with each other through a middle gear; the output end of the transmission gear set is in drive connection with the second base; the middle gear is provided with a gear shaft at the middle portion; and the two ends of the gear shaft are in rotatory connection with the housing.

### BACKGROUND OF THE INVENTION

1. Technical Field

The present invention relates to the field of electric saws, in particular to a transmission mechanism for an electric two-blade saw.

2. Description of Related Art

Electric two-blade saw can be used conveniently without the need of support on the workpiece, and is highly appraised by those in the field for its low cutting vibration, smooth action, high cutting efficiency and labor efficient operation. Conventional electric two-blade saw typically includes a hand-held housing, and the housing is contains a motor, power transmission mechanisms, and a first saw blade and a second saw blade which is driven by the power transmission mechanism. The two saw blades are disposed parallel to each other.

In order to drive the two saw blades to move in the opposite directions at the same time, some saws have two sets of power transmission mechanisms. Each mechanism connects and drives a saw blade. This type of transmission mechanism setup requires many parts and components and is complex. It also has increased volume of the housing making hand-held operation inconvenient. In order to accommodate hand-held operation the size of the parts and components in such transmission mechanism must be reduced. As a result, higher requirements on the processing accuracy and materials of the parts and components are imposed on the manufacturing of the device, increasing the cost and reducing the service life of the device.

To overcome the defects of the above described transmission mechanism, a cam-structured transmission mechanism has been developed. Such transmission mechanism typically comprises a transmission gear set in connection with the motor; the gear set has two output ends; those two output ends are each connected with to a cam or eccentric wheel and drive two saw blades to rotate in opposite directions through those two cams or eccentric wheels. Such transmission mechanism uses far fewer parts and components than the conventional transmission mechanism described above. As a result, the volume of the housing is reduced, and the electric saw can be conveniently held, while reducing the manufacturing cost.

It is well known in the field of electric two-blade saw that the longer the distance of the relative movement of the two saw blades, the higher the cutting efficiency. For the first type of electric two-blade saw, due to the limitation in the holding operation, it is difficult to increase the distance of the relative movement of the two saw blades. For the second type of transmission mechanism driven by the cams or the eccentric wheels, the distance of the relative movement of the two saw blades is related to the size of the cams or the eccentric wheels. To increase the distance of the relative movement of the two saw blades, the size of the cams or the eccentric wheels must also be increased. Since the two eccentric wheels are partly superposed, if the distance travelled by the two saw blades are required to be doubled, the size of the eccentric wheels must also be doubled, and the size of the housing is correspondingly required to be doubled. Additionally, the size of the housing is also limited by the holding operation.

### BRIEF SUMMARY OF THE INVENTION

The technical problem can be solved by the present invention by providing a transmission mechanism for an electric two-blade saw which can greatly increase the relative movement distance between the two saw blades without increasing the size of the housing, resulting in great improvement in efficiency.

The technical solution that the present invention employs to solve the above technical problems is as follows: a transmission mechanism for an electric two-blade saw comprises a transmission gear set installed in a housing and driven to rotate by a motor, a first saw blade and a second saw blade, wherein said first saw blade is installed on a first base; said second saw blade is installed on a second base; said first base is equipped with a first rack, while said second base is equipped with a second rack; said first rack and said second rack are both connected with a middle gear so the two racks are engaged with each other; the output end of said transmission gear set is coupled with said second base; said middle gear is provided with a gear shaft at the middle portion; and the two ends of said gear shaft are connected to said housing in a rotating way.

The transmission gear set can be in a plurality of connection modes with the second rack so as to drive the second rack to move in a reciprocating way; preferably, the second rack is fixedly connected to the first surface of said second base; the second surface away from said first surface of said second base is provided with an accommodating groove; the output end, namely a tail gear, of said transmission gear set, is provided with an eccentric shaft; and the eccentric shaft is inserted into said accommodating groove. This structure is simple and does not increase the volume of the housing.

In the above solution, the two ends of the gear shaft can be directly connected to the housing in a rotating way. As an improvement, the two ends of the gear shaft are each connected with the housing through bearings. The gear shaft of such structure suffers small resistance during rotation and has high working stability.

The transmission gear set can employ a plurality of engagement connection modes; preferably, said transmission gear set comprises a driving gear in drive connection with the output shaft of said motor and a driven gear in engagement with the driving gear, and the driven gear is the tail gear of the transmission gear set. Such structure is simpler, has fewer transmission steps and less energy loss.

Compared with the prior art, the present invention ingeniously employs the mode where two racks and a gear are matched so that the second rack moves opposite to the first rack to replace the cams or eccentric wheels which drives the second rack. Thus, one eccentric wheel can drive two saw blades to move in a reciprocating way in opposite directions at the same time. Additionally, the eccentric distance of the eccentric shaft is directly corresponding to the movement of the two saw blades. In this setup, the movement of the two saw blades can be almost doubled without changing the size of the housing. In such circumstances, the movement distances of the two saw blades are greatly increased without increasing the size of the housing, greatly improving the cutting efficiency. Compared with the transmission mechanism with two cams, if the eccentric distance is increased equivalently in the present invention, the increment in the movement in the present invention would be twice of the prior art.

### BRIEF DESCRIPTION OF THE SEVERAL VIEWS OF THE DRAWINGS

FIG. 1 is a three-dimensional view of the assembly structure in the embodiment of the present invention (bearings not shown).

FIG. 2 is a front view of the assembly structure in the embodiment of the present invention (bearings not shown).

FIG. 3 is a partial three-dimensional structural view of the embodiment of the present invention during operation (a part of the shell not shown).

### DETAILED DESCRIPTION OF THE INVENTION

The present invention is described in further detail with reference to the attached drawings and embodiments.

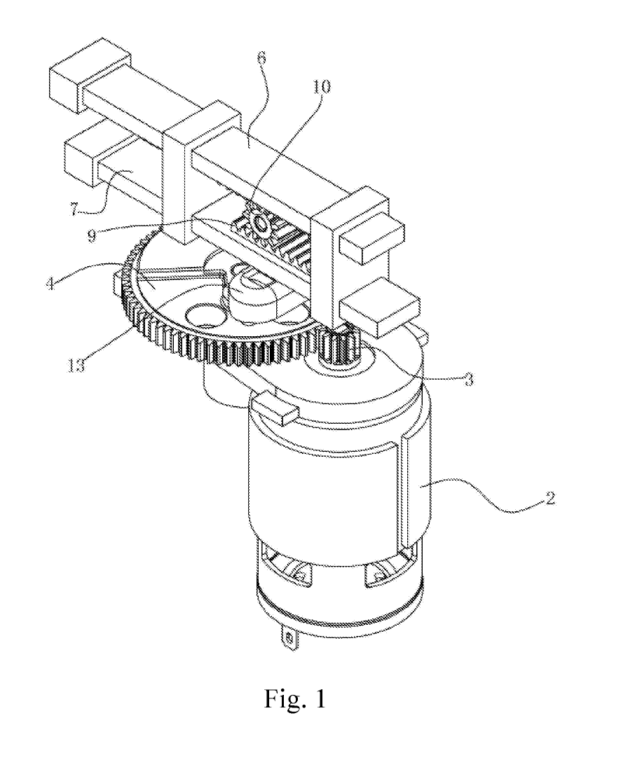

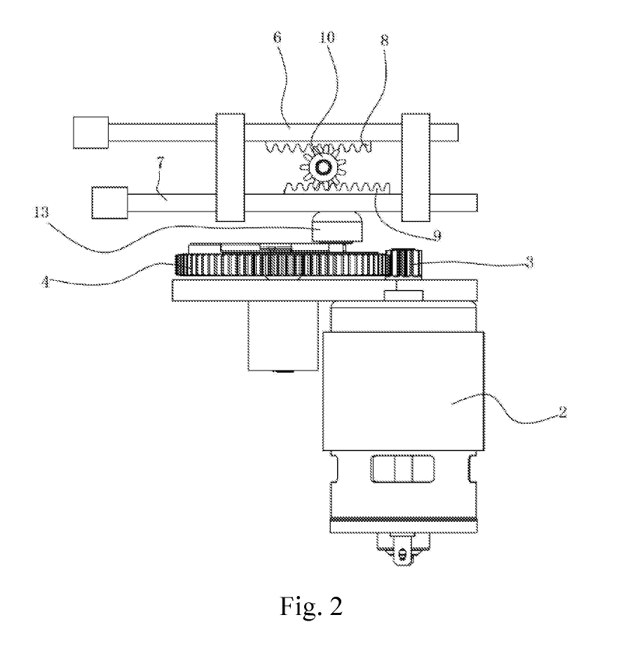

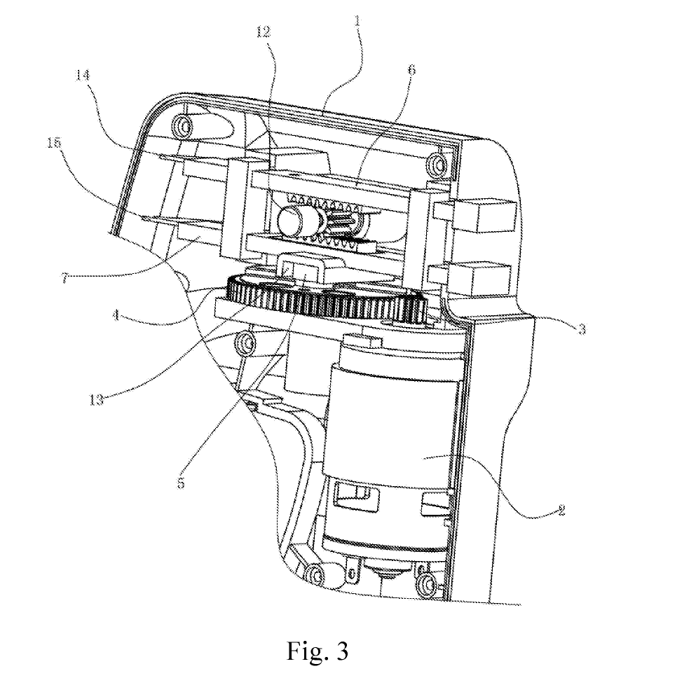

As shown in FIGS. 1-3, a transmission mechanism for a two-blade electric saw can comprise:

a transmission gear set installed in a housing 1 and driven to rotate by a motor 2; the transmission gear set can further comprise a driving gear 3 coupled with with the output shaft of a motor and a driven gear 4 in engagement with the driving gear 3, and the driven gear 4 is the tail gear of the transmission gear set.

The driven gear 4 is eccentrically coupled with an eccentric shaft 5.

Above the transmission gear set are disposed a first base 6 and a second base 7. The first base 6 and the second base 7 are parallel to each other; the two bases are both plate-like structured, with front ends provided with slots for inserting a first saw blade 14 and a second saw blade 15. One surface of the first base 6 and one surface of the second base 7, which face each other, are respectively fixedly connected with a first rack 8 and a second rack 9.

Between the first rack 8 and the second rack 9 is disposed a middle gear 10, and the middle gear is engaged with the first rack 8 and the second rack 9 at the same time. The middle gear is provided with a gear shaft 11 at the middle portion, and the two ends of the gear shaft are connected to the wall of the shaft in a rotating way through bearings 12.

The face where the second rack is in fixed connection is the first surface of the second base, and the back face of the first surface, namely the second surface, is provided with an accommodating groove 13. The accommodating groove may be a recess formed on the second surface of the first base or may protrude from the second surface.

The eccentric shaft 5 is accommodated in the accommodating groove 13.

The working principle of the electric two-blade saw is as follows:

The motor 2 works and drives the driving gear 3 to drive the driven gear 4 to rotate, and then eccentric shaft 5 disposed on the driven gear 4 performs eccentric motion in the accommodating groove 13 to drive the Second base 7 to move in a reciprocating way. The first base drives the first saw blade to move in a reciprocating way while the first rack 8 on the first base drives the middle gear 10 to rotate; the middle gear 10 drives the second rack 9 to drive the second base 7 to move in the opposite direction, thus driving the second saw blade to move in the opposite direction relative to the first saw blade to complete the cutting task.

The transmission gear set can use one eccentric wheel to drive two saw blades to move in a reciprocating way at the same time, and the eccentric distance of the eccentric shaft directly corresponds to the movement of the blades, so a slight increment in the size of the driven gear or slight change to the position of the eccentric position can greatly change the movement journeys of the blades, which greatly increases the movement distances of the two saw blades without increasing the size of the housing, thus greatly improving the cutting efficiency.

What is claimed is:

1. A transmission mechanism for an electric two-blade saw, comprising:
a transmission gear set installed in a housing wherein the transmission gear is driven to rotate by a motor,
a first saw blade and a second saw blade, wherein the said first saw blade is installed on a first base, and the said second saw blade is installed on a second base; wherein the said first base is equipped with a first rack and the said second base is equipped with a second rack; wherein the said first rack and said second rack are engaged with each other through a middle gear with each other through the middle gear; wherein the output end of said transmission gear set is coupled with said second base; wherein a gear shaft is provided in the middle portion of the said middle gear; and wherein the two ends of said gear shaft are connected to said housing in a way so the gear shaft can rotate.

2. The transmission mechanism for the electric two-blade saw according to claim 1, wherein the second rack is fixedly connected to a first surface of said second base;
wherein a second surface opposite of said first surface of said second base further comprising an accommodating groove; wherein a tail gear of said transmission gear set is provided with an eccentric shaft; and wherein the eccentric shaft is inserted into said accommodating groove.

3. The transmission mechanism for the electric two-blade saw according to claims 1 and 2, wherein the two ends of said gear shaft are each connected with said housing through bearings.

4. The transmission mechanism for the electric two-blade saw according to claim 3, wherein said transmission gear set further comprising a driving gear in drive connection with the output shaft of said motor and a driven gear in engagement with the driving gear, and the driven gear is the tail gear of the transmission gear set.
